(19) United States
(12) Patent Application Publication
(10) Pub. No.: US 2015/0100402 A1
(43) Pub. Date: Apr. 9, 2015

(54) Method and System for Conducting Coupon Exchange

(71) Applicant: MPayMe Ltd., Hong Kong (HK)

(72) Inventor: Alessandro GADOTTI, Hong Kong (HK)

(21) Appl. No.: 14/506,705

(22) Filed: Oct. 6, 2014

Related U.S. Application Data
(60) Provisional application No. 61/886,675, filed on Oct. 4, 2013.

(51) Int. Cl. G06Q 30/02; G06Q 20/10

(52) U.S. Cl. CPC G06Q 30/0222; G06Q 20/10
USPC 705/14.23

(57) ABSTRACT

The coupon exchange platform involves multiple merchants, consumers, and coupon providers. Because a merchant usually interacts directly with consumers in commercial activities, a merchant is in the ideal position to distribute coupons, and not only the ones from its own but also those from other sources. As such, the merchants in the system, for appropriate compensations, serve to provide channels for coupon distribution or placements, whereas the coupon providers pay to deliver their coupon through the merchants. The coupon bidding process comprises retrieving the pre-configured coupon acceptance criteria of a merchant; and identifying the matched coupons provided by the coupon providers, wherein each of the one or more matched coupons is associated with a set of coupon offering parameters that satisfy or match the coupon acceptance criteria of the merchant user. The “winning” coupons can be delivered to a consumer upon the completion of the consumer's payment transaction.

### CLAIM FOR DOMESTIC PRIORITY

This application claims priority under 35 U.S.C. §119 to the U.S. Provisional Patent Application No. 61/886,675, filed Oct. 4, 2013, the disclosure of which is incorporated herein by reference in its entirety.

### CROSS-REFERENCES TO RELATED APPLICATIONS

This application is related to the U.S. patent application Ser. No. 13/602,197 filed Sep. 2, 2012, the disclosure of which is incorporated herein by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to systems and methods of distribution, redemption, and management of electronic discount, entitlement, incentive, and promotional coupons, vouchers, and points in an electronic bill payment infrastructure involving multiple consumers, merchants, and providers.

### BACKGROUND

Modern day commerce involves conducting financial transactions through many different channels using a variety of instruments. Physical currency, or cash, has been the most common means when the transacting parties are located away from any banking facility. Other payment methods and systems attempting to supplement or replace physical currencies have appeared over the years. Credit cards, debit cards, Internet online payment services such as PayPal™, and monetary value holding electronic devices and systems, such as the near field communication (NFC) enabled Octopus Card widely used in Hong Kong, China, are some of the examples. Accompany with the various types of payment transaction is the use of discount, entitlement, incentive, and promotional coupons, especially in retail commerce. Similarly, various forms of electronic or virtual forms of discount, entitlement, incentive, and promotional programs such as electronic coupons, vouchers, points, etc. have arisen in recent years. Without the limitation of physical media, these electronic means enable many new ways of delivery and redemption. For instance, for one merchant to deliver other's discount coupons, it is usually an ad hoc exercise for the merchant to coordinate with each coupon provider. With electronic coupons, however, selection of coupon providers and coupon contents can be changed instantly, coupon delivery methods can be easily adjusted for different business conditions.

### SUMMARY

It is an objective of the presently claimed invention to provide an electronic discount/entitlement/promotional/incentive coupon/voucher/point (collectively referred to as “discount coupon”) distribution, redemption, and management method and system (hereinafter referred to as “coupon exchange platform”). It is a further objective of the presently claimed invention to provide such method and system that can be adapted to cooperate with various electronic payment methods and systems, including mobile payment methods and systems utilizing mobile communication devices, barcode, and/or NFC technologies such as that disclosed in the U.S. patent application Ser. No. 13/602,197.

In accordance with various embodiments, the system implementing the present invention comprises a central processing server accessible through a first communication network, such as the Internet; a plurality of users including consumer users, merchant users, and coupon provider users; mobile communication devices and client computing devices that can access the central processing server through the first communication network; and financial institutions, exchanges, and clearance centers connected to the central processing server through a second communication network, which can be the same as the first communication network.

In accordance with various embodiments, the functionalities of the central processing server comprises user account management for managing user accounts and authenticating users, wherein the user accounts contain user identification and banking information, and are stored securely in a database. The banking information includes information on one or more funding sources, such as credit cards, debit cards, and bank accounts; and fund receiving destinations. The central processing server provides the functionality of an electronic repository of credits or monetary units for each user account. The central processing server also provides transaction clearance functionality for processing payments and financial transactions for the users associated with the user accounts. The central processing server has backend network connections and machine-to-machine integration mechanisms, such as application program interfaces (APIs), to connect and interface with financial institutions, financial exchanges, and clearance centers, facilitating the processing of payments and financial transactions for and between the users associated with the user accounts.

In accordance with various embodiments, the central processing server includes a plurality of user interfaces for user interaction using various types of computing devices and mobile communication devices running web browser applications. In addition, the central processing server also includes secure mobile payment and access control server backend APIs for machine-to-machine integration enabling specially-developed applications running in computing devices or mobile communication devices to communicate with the central processing server. These user interfaces and secure mobile payment and access control server backend APIs facilitate the functionalities including, but are not limited to, system administration by administrators, user account management, conducting payment transactions, electronic coupon creation, bidding, distribution, and redemption by users.

In accordance to one aspect of the present invention, the discount coupon distribution, redemption, and management method and system involve generally one or more merchant users, one or more consumer users, and one or more coupon provider users. The merchant users can be retailers and other sellers of goods and services to consumer users. Because a merchant usually interacts directly with consumers in commercial activities, a merchant is in the ideal position to distribute advertisements and promotional materials including discount coupons, and not only the ones from its own but also those from other sources. As such, the merchant users in the system, for appropriate compensations, serve to provide channels for discount coupon distribution or placements, whereas the coupon provider users pay to deliver their coupon through the merchant users. A coupon provider user can also be another merchant user in the system.

In accordance to another aspect of the present invention, the central processing server executes the computer instructions implementing a discount coupon bidding process between a plurality of merchant users and a plurality of coupon provider users. The discount coupon bidding process comprises retrieving one or more coupon acceptance criteria of a merchant user, wherein the merchant user being engaged in a payment transaction with a consumer user, and wherein the one or more coupon acceptance criteria are pre-configured by the merchant user using the central processing user interfaces and stored in the database of the central processing server; and identifying one or more matched coupons provided by the coupon provider users, wherein the one or more matched coupons having coupon offering parameters that are satisfying or matching the coupon acceptance criteria of the merchant user, and wherein the coupon offering parameters of coupon providers are pre-configured by the coupon provider users using the central processing user interfaces stored in the database.

The discount coupon bidding process can be performed upon the completion of a payment transaction between the merchant user and a consumer user and deliver the “winning” (those coupon provider users' coupons with coupon offering parameters that are satisfying or matching the coupon acceptance criteria of the merchant user) coupons to the consumer user by a number ways. The discount coupon bidding process can also be performed independent of a payment transaction and deliver the “winning” coupons to one or more consumers at any point of time.

The coupon delivery mechanisms include, but not limited to, the central processing server automatically adding the “winning” coupons to the consumer user account by generating and storing the data referencing the “winning” coupons and associating with the consumer user account data record in the database of the central processing server, or other electronic payment systems that facilitate payment transactions by the consumer user. This way, the consumer can readily use the “winning” coupons in her next payment transaction.

Once an instance of a “winning” coupon is delivered to the consumer user and/or an instance of a “winning” coupon is redeemed according to the matched asking-bidding condition, the central processing server executes the computer instructions implementing the funds transfer from the coupon provider of the “winning” coupon to the merchant user according to the matched asking-bidding price set for placing the coupon.

Prior to commencing the coupon bidding process, each merchant user, by using the central processing server user interfaces, configures one or more sets of coupon acceptance criteria to screen for the desired coupons that it wants to carry and distribute. The coupon acceptance criteria include, but not limited to, a minimum asking price for the merchant user to carry and distribute a coupon based on each instance of the coupon being sent to its customers (hereinafter referred to as “push”), a minimum asking price for the merchant user to carry and distribute a coupon based on each instance of the coupon being redeemed, timing and frequency of the push, one or more merchant categories that the merchant user belongs to, one or more sales/advertising channels that the merchant user utilizes to market its goods or services through, one or more merchant locations that the merchant user operates in, one or more merchant languages that the merchant user markets its goods or services in, one or more groups or segments of customer that the merchant user desires to be included or excluded for receiving the coupon, one or more blocked coupon provider categories of which the merchant user does not accept coupon bidding from. Each merchant user can configure multiple sets of coupon acceptance criteria of different combinations of criteria value based on its business needs.

Each coupon provider user, by using the central processing server user interfaces, can configure one or more sets of coupon offering parameters to screen for the desired merchant users that it wants to distribute its coupons through. By using the central processing server user interfaces, one or more coupons are first created and the coupons' data records are stored in the database of the central processing server. The coupon provider user then selects the set of coupon offering parameters to associate with each coupon created. The coupon offering parameters include, but not limited to, a maximum bidding price for the merchant user to push each instance of a coupon, a maximum bidding price for each instance of redemption of a coupon, one or more coupon provider categories that the coupon provider user belongs to, one or more desired merchant sales/advertising channels that the merchant user utilizes to market its goods or services through, one or more desired merchant locations that the merchant user operates in, one or more desired merchant languages that the merchant user markets its goods or services in, one or more desired groups or segments of customer of the merchant user that the coupon provider user desires to be included or excluded for receiving the coupon, one or more blocked merchant categories of which the coupon provider user desires not to bid for. A “winning” coupon is found when both sets of the merchant user's coupon acceptance criteria and the coupon provider user's coupon offering parameters are satisfied and matched by each other.

In accordance to yet another aspect of the present invention, an analytic tool is provided for performing analysis on the coupon distribution performances. The coupon distribution performances can be measured by the number of coupon push by coupon provider users, coupon provider categories, merchant users, merchant categories, merchant locations, and merchant sales/advertising channels within a certain period of time. The coupon distribution performances can also be measured by the number of coupon redemption, or redemption rate, within a certain period of time. Using the central processing server user interfaces, the merchant users and coupon provider users can request for a number of configurable analysis reports to be generated.

### BRIEF DESCRIPTION OF THE DRAWINGS

Embodiments of the invention are described in more detail hereinafter with reference to the drawings, in which

FIG. 1 shows a block diagram illustrating an exemplary embodiment of the presently claimed coupon exchange platform;

FIG. 2 shows a block diagram illustrating a sample operation of an exemplary embodiment of a process of coupon bidding between a plurality merchant user and a plurality of coupon provider users using the presently claimed coupon exchange platform.

### DETAILED DESCRIPTION

In the following description, methods and systems of electronic discount/entitlement/promotional/incentive coupon/voucher/point (collectively referred to as “discount coupon”) distribution, redemption, and management (hereinafter referred to as “coupon exchange platform”) and the like are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

System:

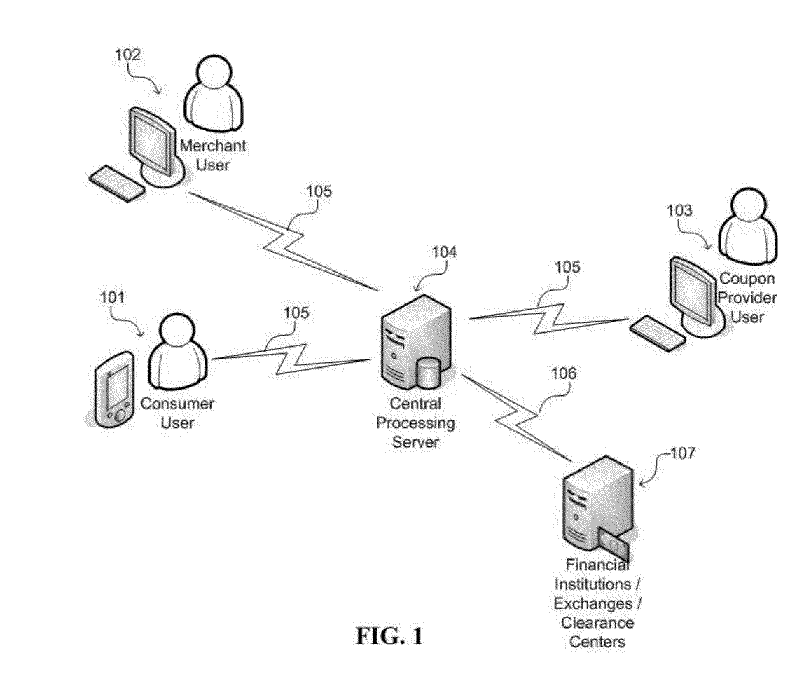

Referring to FIG. 1. In accordance with various embodiments the presently claimed invention comprises a central processing server 104 accessible through a first communication network 105, which can be the Internet, a telecommunication network, or any network supporting the TCP/IP protocol; a plurality of users including consumer users 101, merchant users 102, and coupon provider users 103, each associating with a user account with its data record stored in the central processing server 104; financial institutions, exchanges and clearance centers 107 connected to the central processing server 104 through a second communication network 106, which can be the same as the first communication network 105 or a separate communication network.

In accordance with various embodiments, the functionalities of the central processing server 104 comprises user account management for managing user accounts and authenticating users, wherein a data record of a user account comprises the user's identification and banking information. The banking information includes information on one or more funding sources, such as credit cards, debit cards, and bank accounts; and fund receiving destinations. The central processing server 104 provides the functionality of an electronic repository of credits or monetary units for each user account. The central processing server 104 also provides transaction clearance functionality for processing payments and financial transactions for the users associated with the user accounts. The central processing server 104 has backend network connections and machine-to-machine integration mechanisms, such as APIs, to connect and interface with the financial institutions, financial exchanges, and clearance centers 107, facilitating the processing of payments and financial transactions for and between the consumer users 101, merchant users 102, and coupon provider users 103 associated with the user accounts.

In accordance with various embodiments, the central processing server 104 includes a first group of user interfaces for consumer users 101 accessible by the mobile communication devices and other computing devices through the first communication network 105; and a second group of user interfaces for merchant users 102 and coupon provider users 103 accessible by the mobile communication devices, other computing devices, and the POS terminals/counters/kiosks through the first communication network 105. Both groups of user interfaces include interactive transactional web sites that can be displayed in web browser applications running in the mobile communication devices and other computing devices, and user interfaces that are specifically designed for specifically-developed software applications running in the mobile communication devices and other computing devices. One exemplary embodiment of such user interface is a mobile application (App) running on the iOS operating system developed by Apple Inc. Another exemplary embodiment of such user interface is a mobile application (App) running on the Android operating system developed by Google Inc. The central processing server also provides a third group of user interfaces for system administrative users accessible by the mobile communication devices and other computing devices through the first communication network 105.

In addition to the groups of user interfaces, the central processing server 104 also includes secure server backend APIs for machine-to-machine integration, enabling specifically-developed software applications running in mobile communication devices or other computing devices to communicate with the central processing server 104. In accordance to various embodiments, the machine-to-machine data interchanges via the secure server backend APIs supports industry standards including, but are limited to, XML and JSON.

These user interfaces and secure server backend APIs facilitate the functionalities including, but are not limited to, system administration by administrators, user account management, conducting payment transactions, electronic coupon creation, bidding, distribution, and redemption by users.

In accordance with various embodiments, the central processing server 104 includes a database for preserving data records of the user accounts, coupons, coupon asking criteria data, coupon bidding parameter data, information on the financial institutions, financial exchanges, and clearance centers 107, system configuration data, and other meta data. The database can be implemented in the same physical computer server of the central processing server 104, or in a separate physical computer server. Exemplary embodiments of the database are various commercially available relational database management systems such as Oracle® Database and Microsoft® SQL Server.

Coupon Bidding Process:

In accordance to one aspect of the present invention, the coupon exchange platform involve generally one or more merchant users, one or more consumer users, and one or more coupon provider users. The merchant users can be retailers and other sellers of goods and services to consumer users. Because a merchant usually interacts directly with consumers in commercial activities, a merchant is in the ideal position to distribute advertisements and promotional materials including discount coupons, and not only the ones from its own but also those from other sources. As such, the merchant users in the system, for appropriate compensations, serve to provide channels for discount coupon distribution or placements, whereas the coupon provider users pay to deliver their coupon through the merchant users. A coupon provider user can also be another merchant user in the system.

In accordance to another aspect of the present invention, the central processing server executes the computer instructions implementing a coupon bidding process between a plurality of merchant users and a plurality of coupon provider users. The coupon bidding process comprises retrieving one or more sets of coupon acceptance criteria of a merchant user, wherein the merchant user being engaged in a payment transaction with a consumer user, and wherein the one or more sets of coupon acceptance criteria are pre-configured by the merchant user using the central processing user interfaces and stored in the database of the central processing server; and identifying one or more matched coupons provided by the coupon provider users, wherein each of the one or more matched coupons is associated with a set of coupon offering parameters that satisfy or match at least one of the sets of coupon acceptance criteria of the merchant user, and wherein the sets of coupon offering parameters of coupon providers are pre-configured by the coupon provider users using the central processing user interfaces stored in the database.

The discount coupon bidding process can be performed upon the completion of a payment transaction between the merchant user and a consumer user and deliver the “winning” (those coupon provider users' coupons with coupon offering parameters that are satisfying or matching the coupon acceptance criteria of the merchant user) coupons to the consumer user by a number ways. The discount coupon bidding process can also be performed independent of a payment transaction and deliver the “winning” coupons to one or more consumers at any point of time.

The coupon delivery mechanisms include, but not limited to, at the time of the completion of a payment transaction between the coupon carrying merchant user and the consumer user, the central processing server automatically adding the “winning” coupons to the consumer user account by generating and storing the data referencing the “winning” coupons and associating with the consumer user account data record in the database of the central processing server, or other electronic payment systems that facilitate payment transactions by the consumer user. This way, the consumer can readily use the “winning” coupons in her next payment transaction. Another coupon delivery mechanism is to display the discount coupon with a barcode, which can be a Quick Response (QR) code, in one or more of the sales/advertising channels employed by the discount coupon carrying merchant user, wherein the consumer users who are exposed to the sales/advertising channels can receive the discount coupon by optically capturing the barcode of the discount coupon using their camera-equipped mobile communication devices. The barcode is encoded with reference information of the coupon for retrieving the coupon data stored in the central processing server. Data for generating the barcode is generated by and stored in the central processing server at the time of coupon creation by the coupon provider user. By using the central processing server user interfaces, the coupon carrying merchant user can retrieve the barcode data of the “winning” coupons to facilitate the delivery of the “winning” coupons. Similarly, Near Field Communication (NFC) transmitters can be used in place of the barcodes for transmitting the reference information on the discount coupons to the consumer users' mobile communication devices that are equipped with NFC interrogators.

Once an instance of a “winning” coupons is delivered to the consumer user and/or an instance of a “winning” coupon is redeemed according to the matched asking-bidding condition as the changes in the data records of the consumer users indicate as such, the central processing server executes the computer instructions implementing the funds transfer from the coupon provider of the “winning” coupon to the merchant user according to the matched asking-bidding price set for placing the coupon.

Prior to commencing the coupon bidding process, each merchant user, by using the central processing server user interfaces, configures one or more sets of coupon acceptance criteria to screen for the desired coupons that it wants to carry and distribute. The coupon acceptance criteria include, but not limited to, a minimum asking price for the merchant user to carry and distribute a coupon based on each instance of the coupon being sent to its customers (hereinafter referred to as “push”), a minimum asking price for the merchant user to carry and distribute a coupon based on each instance of the coupon being redeemed, timing and frequency of the push, one or more merchant categories that the merchant user belongs to, one or more sales/advertising channels that the merchant user utilizes to market its goods or services through, one or more merchant locations that the merchant user operates in, one or more merchant languages that the merchant user markets its goods or services in, one or more groups or segments of customer that the merchant user desires to be included or excluded for receiving the coupon, one or more blocked coupon provider categories of which the merchant user does not accept coupon bidding from. Each merchant user can configure multiple sets of coupon acceptance criteria of different combinations of criteria value. The one or more sets of coupon acceptance criteria configured by each merchant user are then stored in the database of the central processing server.

The possible values for merchant category can be arbitrary as the merchant category is used to group the merchant users by any particular factor. Likewise, the possible values for coupon provider category can be arbitrary as well. The possible values for the timing and frequency of the push include, but not limited to, maximum number of push during specific repeated or non-repeated time period. The possible values for the merchant sales/advertising channels include, but not limited to, online advertisements, television and radio commercials, advertisement on printed media, and billboard advertisements. The possible values for groups or segments of customer include, but not limited to, specific gender, age groups, occupations, and income levels.

Each coupon provider user, by using the central processing server user interfaces, can configure one or more sets of coupon offering parameters to screen for the desired merchant users that it wants to distribute its coupons through. By using the central processing server user interfaces, one or more coupons are first created and the coupons' data records are stored in the database of the central processing server. The coupon provider user then selects the set of coupon offering parameters to associate with each coupon created. The coupon offering parameters include, but not limited to, a maximum bidding price for the merchant user to push each instance of a coupon, a maximum bidding price for each instance of redemption of a coupon, one or more coupon provider categories that the coupon provider user belongs to, one or more desired merchant sales/advertising channels that the merchant user utilizes for marketing its goods or services through, one or more desired merchant locations that the merchant user operates in, one or more desired merchant languages that the merchant user markets its goods or services in, one or more desired groups or segments of customer of the merchant user that the coupon provider user desires to be included or excluded for receiving the coupon, one or more blocked merchant categories of which the coupon provider user desires not to bid for. Each coupon provider user can configure multiple sets of coupon offering parameters of different combinations of parameter value. The one or more sets of coupon offering parameters configured by each coupon provider user are then stored in the database of the central processing server.

By using the central processing server user interfaces, the merchant user can signal to coupon provider users of its invitation for coupon bidding by activating one or more sets of coupon acceptance criteria configured. A “winning” coupon is found when both sets of the merchant user's coupon acceptance criteria and the coupon provider user's coupon offering parameters are satisfied or matched by each other. The central processing server automatically executes the discount coupon bidding process, finds the “winning” coupons for each activated set of coupon acceptance criteria, notifies the merchant user and the coupon provider user of the “winning” coupons, and causes to deliver the “winning” coupons. The aforementioned processes can be continuously executed by the central processing server such that new “winning” coupons can be found and be delivered as coupon provider users add new coupons and configure new sets of coupon offering parameters in the central processing server. Alternatively, the aforementioned processes can be executed in an event driven manner, such as when a payment transaction is completed between a consumer user and the merchant user.

In accordance to yet another aspect of the present invention, an analytic tool is provided for performing analysis on the coupon distribution performances. The coupon distribution performances can be measured by the number of push by coupon provider users, categories of coupon provider, merchant users, categories of merchant, merchant locations, and merchant sales/advertising channels within a set period of time. The coupon distribution performances can also be measured by the number of coupon redemption, or redemption rate, within a set period of time. Using the central processing server user interfaces, the merchant users and coupon provider users can request for a number of configurable analysis reports to be generated.

A Sample Coupon Bidding Process:

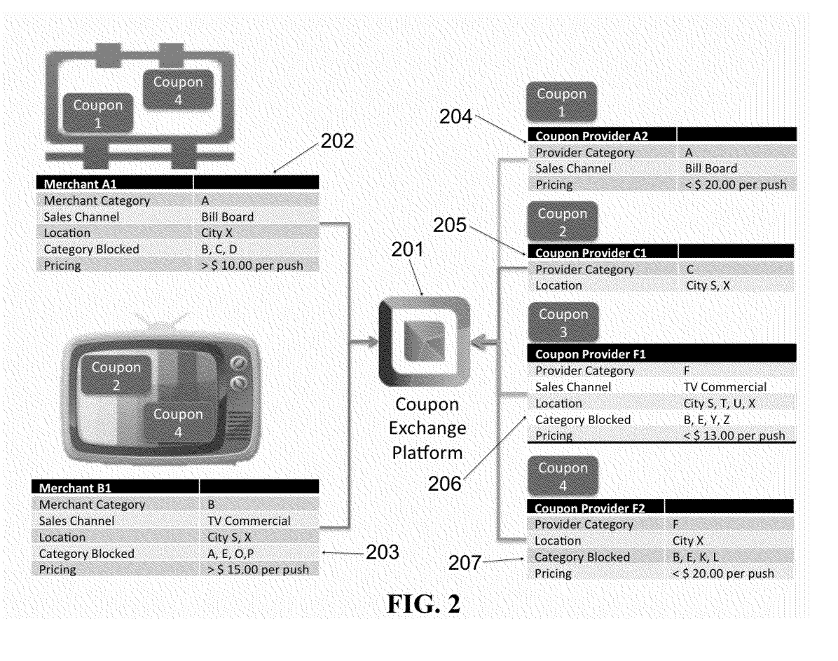

FIG. 2 shows a logical block diagram of a sample operation of an exemplary embodiment of the discount coupon bidding process between a plurality of merchant users and a plurality of coupon provider users in accordance to the present invention. In this example, Merchant A (202) belongs to the merchant category “A” and has configured a set of coupon acceptance criteria consisting of sales/advertising channel being “Billboard”, merchant location including “City X”, blocked coupon provider categories including “B”, “C”, and “D”, and minimal asking price per push being $10.00; Merchant B (203) belongs to the merchant category “B” and has configured a set of coupon acceptance criteria consisting of sales/advertising channel being “TV Commercial”, merchant locations including “City S” and “City X”, blocked coupon provider categories including “A”, “E”, “0”, and “P”, and minimal asking price per push being $15.00; Coupon Provider A2 (204) belongs to coupon provider category “A” and configured a set of coupon offering parameters for Coupon 1 consisting of desired merchant sales/advertising channels that include “Billboard”, and maximum bidding price for the merchant user to push each instance of a coupon being $20.00; Coupon Provider C1 (205) belongs to coupon provider category “C” and configured a set of coupon offering parameters for Coupon 2 consisting of desired merchant locations that include “City S” and “City X”; Coupon Provider F1 (206) belongs to coupon provider category “F” and configured a set of coupon offering parameters for Coupon 3 consisting of desired merchant sales/advertising channels that include “TV Commercial”, desired merchant locations that include “City S”, “City T”, “City U”, and “City X”, blocked merchant categories that include “B”, “E”, “Y”, and “Z”, and maximum bidding price for the merchant user to push each instance of a coupon being $13.00; and Coupon Provider F2 (207) belongs to coupon provider category “F” and configured a set of coupon offering parameters for Coupon 4 consisting of desired merchant locations that include “City X”, blocked merchant categories that include “B”, “E”, “K”, and “L”, and maximum bidding price for the merchant user to push each instance of a coupon being $20.00.

As the discount coupon bidding process is executed by the central processing server, the set of coupon offering parameters for Coupon 1 and the set for Coupon 4 are determined to satisfy or match the set of coupon acceptance criteria configured by Merchant A1. Thus, Coupon 1 and Coupon 4 are the “winning” coupons for Merchant A1. Also, the set of coupon offering parameters for Coupon 2 and the set for Coupon 4 are determined to satisfy or match the set of coupon acceptance criteria configured by Merchant B1. Thus, Coupon 2 and Coupon 4 are the “winning” coupons for Merchant B1.

The embodiments disclosed herein may be implemented using general purpose or specialized computing devices, mobile communication devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, mobile communication devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Exemplary embodiments of mobile communication devices include, but are not limited to, mobile telephones, mobile telephones with personal computer like capability (commonly referred to as “smartphones”), electronic personal digital assistants (PDAs), portable computers with wired or wireless wide-area-network and/or telecommunication capability such as tablet personal computers and “netbook” personal computers.

Exemplary embodiments of POS terminals/counters include, but are not limited to, non-electronic cash registry machines, electronic cash registry machines, electronic kiosks, general purpose or specialized computing devices configured to execute POS software.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A computer implemented method for conducting an electronic discount, entitlement, or incentive coupon, voucher, or point distribution, consumption, and management, comprising:
executing, by a first computer processor, a coupon bidding process, wherein the coupon bidding process comprises:
retrieving, by the first computer processor, one or more coupon acceptance criteria of a merchant, wherein the merchant being engaged in a payment transaction with a consumer, and wherein the one or more coupon acceptance criteria of the merchant are configurable by the merchant and stored in a database; and
identifying, by the first computer processor, one or more matched coupons provided by one or more coupon providers, wherein the one or more matched coupon having coupon offering parameters that are satisfying or matching the coupon acceptance criteria of the merchant, and wherein the coupon offering parameters of coupon providers are stored in the database; and
delivering, by the first computer processor, the one or more matched coupons to the consumer.

2. The method of claim 1, wherein the delivery of the matched coupons to the consumer is performed upon completion of the payment transaction that causes a fund transfer between the consumer and the merchant.

3. The method of claim 1, wherein the coupon bidding process is executed upon completion of the payment transaction that causes a fund transfer between the consumer and the merchant.

4. The method of claim 1, wherein the delivery of the one or more matched coupons to the consumer is by generating and storing data referencing the one or more matched coupons and associating with the consumer user account data record in the database, and wherein the one or more matched coupons are readily usable by the consumer.

5. The method of claim 1, wherein the delivery of the one or more matched coupons to the consumer is by display of the one or more matched coupons on physical media or electronic devices.

6. The method of claim 1,
wherein the coupon acceptance criteria include a minimum asking price;
wherein the coupon offering parameters include a maximum bidding price; and
wherein is the maximum bidding price is satisfying the minimum asking price if the maximum bidding price is equal or higher than the minimum asking price.

7. The method of claim 1,
wherein the coupon offering parameters include one or more desired categories of merchant of which a coupon provider desires to bid for coupon delivery through;
wherein the coupon acceptance criteria include one or more merchant categories that the merchant belongs to; and
wherein the one or more desired categories match the one or more merchant categories that the merchant belongs to if at least one of the one or more desired categories is among the one or more merchant categories that the merchant belongs to.

8. The method of claim 1,
wherein the coupon offering parameters include one or more desired coupon delivery mechanisms of which a coupon provider desires to bid for coupon delivery by;
wherein the coupon acceptance criteria include one or more merchant coupon delivery mechanisms that the merchant is equipped with; and
wherein the one or more desired coupon delivery mechanisms match the one or more merchant coupon delivery mechanisms that the merchant is equipped with if at least one of the one or more desired coupon delivery mechanisms is among the one or more merchant coupon delivery mechanisms that the merchant is equipped with.

9. The method of claim 1,
wherein the coupon offering parameters include one or more desired coupon delivery locations of which a coupon provider desires to bid for coupon delivery at;
wherein the coupon acceptance criteria include one or more merchant locations that the merchant is distributing or presenting coupons; and
wherein the one or more desired coupon delivery locations match the one or more merchant locations if at least one of the one or more desired coupon delivery locations is among the one or more merchant locations.

10. The method of claim 1,
wherein the coupon offering parameters include one or more blocked merchant categories of which a coupon provider desires not to bid for coupon delivery through;
wherein the coupon acceptance criteria include one or more merchant categories that the merchant belongs to; and
wherein the one or more blocked merchant categories match the one or more merchant categories that the merchant belongs to if none of the one or more blocked merchant categories is among the one or more merchant categories that the merchant belongs to.

11. The method of claim 1,
wherein the coupon acceptance criteria include one or more blocked coupon provider categories of which a merchant does not accept coupon bidding from;
wherein the coupon offering parameters include one or more coupon provider categories that the coupon provider belongs to; and
wherein the one or more coupon provider categories that the coupon provider belongs to satisfy the one or more blocked coupon provider categories of which a merchant does not accept coupon bidding from if none of the one or more coupon provider categories that the coupon provider belongs to is among the one or more blocked coupon provider categories of which a merchant does not accept coupon bidding from.
